(19) United States
(12) Patent Application Publication
(10) Pub. No.: US 2024/0025025 A1
(43) Pub. Date: Jan. 25, 2024

(54) Combination hand tool having a hammer, a hatchet, and two types of screw and nail pullers

(71) Applicant: Anthony Labbe, Lac- Poulin (CA)

(72) Inventor: Anthony Labbe, Lac- Poulin (CA)

(21) Appl. No.: 18/222,556

(22) Filed: Jul. 17, 2023

(30) Foreign Application Priority Data
Jul. 20, 2022 (GB) 2210587.8

(51) Int. Cl. B25F 1/00; B25G 1/10

(52) U.S. Cl. CPC B25F 1/006; B25G 1/10

(57) ABSTRACT

The present invention discloses a versatile combination hand tool offering enhanced functionality and user convenience. The combination tool has a durable steel head member which incorporates two distinct portions: a hammering portion and a hatchet portion. The hammering section features a flat face for efficient strikes and two pairs of claws for nail or screw pulling. The hatchet section, tapering from the hammering portion, houses a nail-pulling notch located opposite the top face of the head member, and two sharp edges for cutting or chopping tasks. A handle member extends perpendicularly from the head member and is overlaid with a grip-enhancing material for secure handling. This innovative tool design effectively integrates the functionalities of a standard hammer, a nail-puller, and a hatchet, potentially replacing multiple individual tools with a solitary, cost-effective, and convenient device.

### CROSS-REFERENCE TO RELATED APPLICATIONS

The present application claims priority to UK request 2210587.8 filed on Jul. 20, 2022, entitled “Combination hand tool having a hammer, a hatchet, and two types of screw and nail pullers”, the disclosure of which is hereby incorporated in its entirety at least by reference.

### BACKGROUND OF THE INVENTION

### 1. Field of the Invention

The present invention relates to hand tools but more particularly a combination hand tool having a hammer, a hatchet, and two types of screw and nail pullers.

### 2. Description of Related Art

The concept of combination tools is deeply rooted in history, dating back centuries. A quintessential example is the carpenter's hammer, ingeniously designed with a pair of claws that effectively pull out nails. Similarly, tools amalgamating a hammer head on one end with a hatchet blade on the opposing end have also garnered substantial recognition for their versatility and multi-functional utility. Another variant in this space includes combination crowbar hammers, distinguished by the nail-pulling component located at the handle's base, offering a unique angle for the claws compared to the conventional placement at the head. However, despite these historic and widely-accepted innovations in combination tools, there remains a substantial demand for newer, more diverse types of such multi-functional instruments. This highlights the continuous need for progression and advancement within the field of combination tools. Consequently, a combination hand tool having a hammer, a hatchet, and two types of screw and nail pullers is provided.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In one aspect of the invention, a combination hand tool is provided, comprising a head member, wherein the head member forms a hammering portion and a hatchet portion; a handle member extending perpendicularly from the head member, overlaid with a grip-enhancing material; wherein the hammering portion essentially consists of a flat face and two pairs of nail or screw pulling claws; and, wherein the hatchet portion tapers from the hammering portion, with a nail-pulling notch located opposite a top face of the head member, and two sharp edges on either side of the nail-pulling notch.

In one embodiment, the head member is formed with a durable steel. In another embodiment, both the hammering portion and the hatchet portion undergo heat treatment. In one embodiment, the handle member is composed of a material selected from a group consisting of wood, metal, and reinforced plastic. In one embodiment, the grip-enhancing material is selected from a group consisting of rubber and silicone.

The foregoing has outlined rather broadly the more pertinent and important features of the present invention so that the detailed description of the invention that follows may be better understood and so that the present contribution to the art can be more fully appreciated. Additional features of the invention, which will be described hereinafter, form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF THE DRAWINGS

Other features and advantages of the present invention will become apparent when the following detailed description is read in conjunction with the accompanying drawings, in which:

FIG. 1 is an isometric view of a combination tool having a hammer, a hatchet, and two types of screw and nail pullers according to an embodiment of the present invention;

FIG. 2A is a front view of the combination tool;

FIG. 2B is a top view of the combination tool; and,

FIG. 2C is a side view of the combination tool.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a combination tool having a hammer, a hatchet, and two types of screw and nail pullers according to an embodiment of the present invention.

It is to be understood that the terminology used herein is for the purpose of describing particular embodiments only and is not intended to be limiting. The terms “a” or “an,” as used herein, are defined to mean “at least one.” The term “plurality,” as used herein, is defined as two or more. The term “another,” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time. These terms generally refer to a range of numbers that one of skill in the art would consider equivalent to the recited values (i.e., having the same function or result). In many instances these terms may include numbers that are rounded to the nearest significant figure.

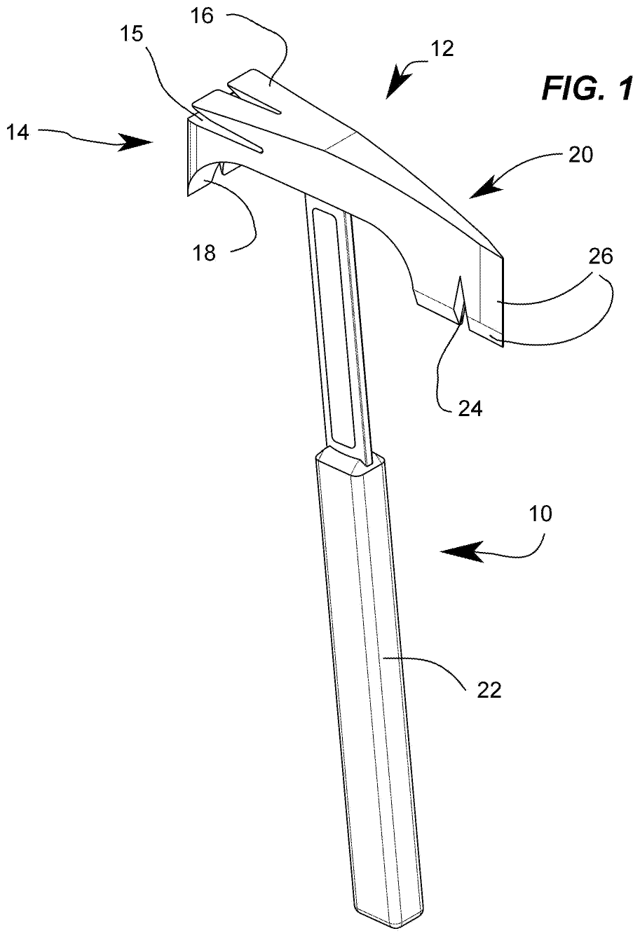

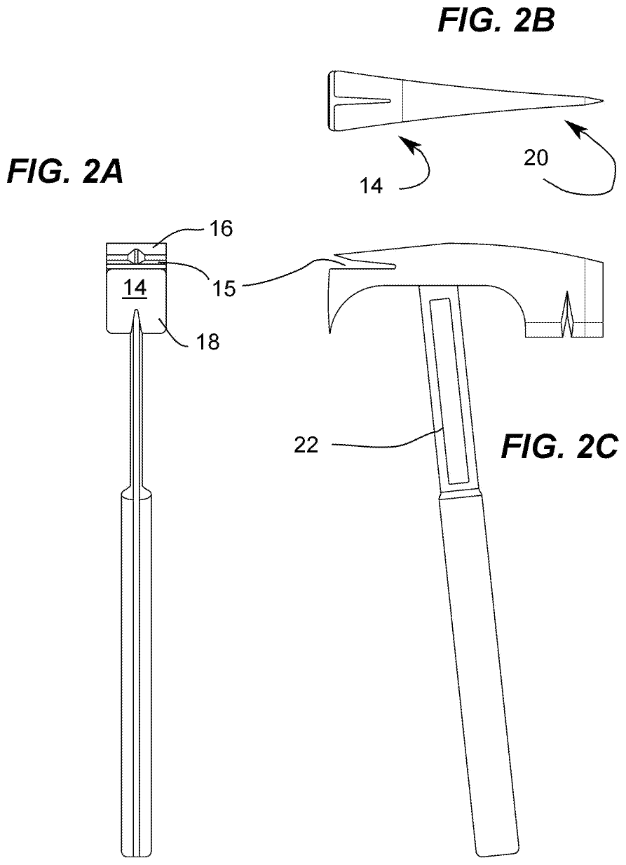

Referring now to any of the accompanying FIGS. 1-2C, a versatile combination tool 10 is illustrated. Advantageously, the combination tool 10 is comprised of a head member 12, which bifurcates into two distinct segments: a hammering section 14, and a hatchet section 20.

In one embodiment, the hammering portion 14 comprises a flat face, beneficial for delivering efficient, direct strikes. Simultaneously, it incorporates a first and a second pair of nail or screw pulling ears or claws, respectively identified as 16 and 18. In one embodiment, the first pair of claws 16 is situated at the top of the hammering section 14, forming a distinctive wedged “V” shape, labeled as 15. This shape aids in separating the first pair of claws 16 from the second pair of claws 18. The second pair of claws 18 is strategically located at the front of the hammering section 14 and also mimics a similar wedged “V” shape. The multi-use function provides an enhanced user experience and broadens the combination tool's application range.

In one embodiment, the head member 12 is tapered to merge seamlessly into the hatchet portion 20. In some embodiments, the hatchet portion 20 houses a nail pulling notch 24 configured for nail-pulling tasks. In one embodiment, this notch 24 is situated opposite the top face of the head member, an arrangement that augments accessibility and ease of use. In some embodiments, two sharp edges 26, flank this notch, amplifying the hatchet's cutting or chopping efficiency.

In some embodiments, the head member is constructed or forged from durable steel, and the hammering section 14 and hatchet section 20 might be sculpted from a single steel piece or an amalgamation of steel members forged or bound together. In various embodiments, both the hammering section 14 and the hatchet section 20 can undergo heat treatment, a well-established procedure in the field, to further bolster their resilience and performance.

Traditionally, the hand tool 10 features a handle member 22, extending perpendicularly from the head member 12. A range of material options is available for the handle, such as wood, metal, or reinforced plastic, selected based on the end-user's preference and the tool's intended application. The handle can be enveloped in various grip-enhancing materials like rubber or silicone, ensuring comfortable and secure handling while operating the tool.

Advantageously, this inventive design of the combination hand tool considerably enhances its overall functionality. The tool encapsulates the capabilities of a standard hammer, a nail-puller, and a hatchet within a single framework. This enables the replacement of multiple individual tools with a single device, offering practical benefits in terms of cost, space, and convenience.

Although the invention has been described in considerable detail in language specific to structural features, it is to be understood that the invention defined in the appended claims is not necessarily limited to the specific features described. Rather, the specific features are disclosed as exemplary forms of implementing the claimed invention. In other words, the terminology and phraseology used in this description and the abstract are for illustrative purposes and should not be considered as limiting. In other words, the terminology and phraseology used in this description and the abstract are for illustrative purposes and should not be considered limiting. Therefore, while exemplary illustrative embodiments of the invention have been described, numerous variations and alternative embodiments will occur to those skilled in the art. Such variations and alternative embodiments are contemplated, and can be made without departing from the spirit and scope of the invention.

It should further be noted that throughout the entire disclosure, the labels such as left, right, front, back, top, bottom, forward, reverse, clockwise, counterclockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, references to “first,” “second,” “third,” and so fourth members throughout the disclosure (and in particular, claims) are not used to show a serial or numerical limitation but instead are used to distinguish or identify the various members of the group.

What is claimed is:

1. A combination hand tool comprising:
a head member that forms both a hammering portion and a hatchet portion;
a handle member extending perpendicularly from the head member, overlaid with a grip-enhancing material;
wherein the hammering portion essentially consists of a flat face and two pairs of nail or screw pulling claws; and,
wherein the hatchet portion tapers from the hammering portion, with a nail-pulling notch located opposite a top face of the head member, and two sharp edges on either side of the nail-pulling notch.

2. The combination hand tool of claim 1, wherein the head member is formed with a durable steel.

3. The combination hand tool of claim 2, wherein both the hammering portion and the hatchet portion undergo heat treatment.

4. The combination hand tool of claim 1, wherein the handle member is composed of a material selected from a group consisting of wood, metal, and reinforced plastic.

5. The combination hand tool of claim 1, wherein the grip-enhancing material is selected from a group consisting of rubber and silicone.
